(19) United States
(12) Patent Application Publication
(10) Pub. No.: US 2016/0110777 A1
(43) Pub. Date: Apr. 21, 2016

(54) APPARATUS, SYSTEM AND METHOD TO DIRECT CHARITABLE GIVING

(71) Applicant: Soul Soup, Newport Beach, CA (US)

(72) Inventor: Chad Steelberg, Newport Beach, CA (US)

(21) Appl. No.: 14/861,949

(22) Filed: Sep. 22, 2015

Related U.S. Application Data
(60) Provisional application No. 62/053,623, filed on Sep. 22, 2014.

(51) Int. Cl. G06Q 30/02; G06Q 20/40

(52) U.S. Cl. CPC G06Q 30/0279; G06Q 20/40

(57) ABSTRACT

The present invention provides a method for making charitable contributions by collecting information related to at least one attribute associated with at least one targeted recipient of a contribution at one of a plurality of service provider locations, providing the information to at least one server communicatively coupled to at least one donor accessible application, wherein said application is resident on a device having a tangible computing processor, the processor in data communication with a non-transitory computer memory that stores instructions which, when executed on the processor, provides to the at least one donor a graphical user interface, and receiving through the at least one donor accessible application an authorization to provide a contribution from the at least one donor to the at least one targeted recipient at one of the plurality of service provider locations.

### CROSS-REFERENCE TO RELATED APPLICATIONS

This application claims priority to U.S. Application Ser. No. 62/053,623, filed Sep. 22, 2014, entitled: “APPARATUS, SYSTEM AND METHOD TO DIRECT CHARITABLE GIVING” which is hereby incorporated by reference.

### FIELD OF THE DISCLOSURE

The present disclosure relates to charitable giving, and, more specifically, to an apparatus, system and method to direct charitable giving.

### BACKGROUND

Charitable giving is very well known. Moreover, some types of charitable giving in so-called “off-line” forms, such as selecting a child in a foreign country to sponsor, or a village to which money is to be sent, are also well known. However, there has historically been no “on-line” methodology whereby dedicated donations can be made, such as to local persons at a soup kitchen.

### BRIEF DESCRIPTION OF THE FIGURES

The present disclosure will become more fully understood from the detailed description given herein below and the accompanying drawings which are given by way of illustration only, and which thus do not limit the present disclosure.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

Exemplary embodiments are provided throughout so that this disclosure is sufficiently thorough and fully conveys the scope of the disclosed embodiments to those who are skilled in the art. Numerous specific details are set forth, such as examples of specific components, devices, and methods, to provide this thorough understanding of embodiments of the present disclosure. Nevertheless, it will be apparent to those skilled in the art that specific disclosed details need not be employed, and that exemplary embodiments may be embodied in different forms. As such, the exemplary embodiments should not be construed to limit the scope of the disclosure. In some exemplary embodiments, well-known processes, well-known device structures, and well-known technologies may not be described in detail.

The terminology used herein is for the purpose of describing particular exemplary embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The steps, processes, and operations described herein are not to be construed as necessarily requiring their respective performance in the particular order discussed or illustrated, unless specifically identified as a preferred order of performance. It is also to be understood that additional or alternative steps may be employed.

As persons in need enter a location at which such persons may receive goods or services, an opportunity arises for charitable giving by others with regard to a particular one or particular ones of the persons in need. By way of non-limiting example, as persons in need enter a location, such as a soup kitchen, a photograph of each entering individual may be taken, with his or her permission. Thereafter, and preferably in substantially real time, photographs of such persons entering, and/or information uniquely associated with those persons such as may be received as responses to inquiries from the entering persons as those persons enter, may be uploaded to an App, the Cloud, or the like. That is, photos and/or information with regard to entering persons may be uploaded from the location upon receipt particularly to servers for unique Apps, such as Facebook, Amazon, or the like, or the obtained data maybe uploaded to a central location from which other applications may obtain the information with permission.

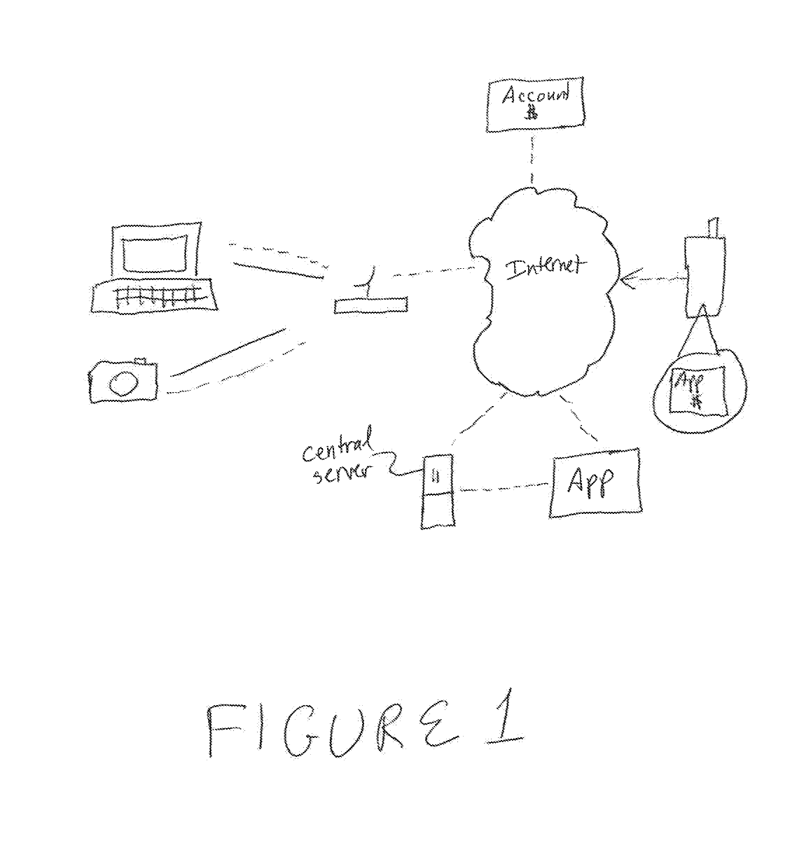

This uploading may be performed as illustrated in FIG. 1. The camera (and/or the upload point of the entered data regarding the person in need) may upload to a desktop computer, laptop, or smartphone, such as via a wired or wireless connection, whereafter an upload to the Cloud may occur, or the picture taking/data entry device may upload directly to the Cloud, by way of non-limiting example.

Once the obtained data regarding entering persons is made available, either directly or from a central server, such as may reside in the Cloud as shown in FIG. 1, such as to one or more Apps, the information may post to the Apps and may be reviewable to users of the App who wish to give charitable donations. Accordingly, a charitable giver may dedicate his or her charitable donation uniquely to a particular recipient who has recently entered the location at which the goods or services are provided. The charitable giver may select the designated donation recipient by photograph, received information, combinations thereof, or the like.

The charitable donation may be received directly in the App in which the donation designation was made, such as by a click-to-pay, micro-transaction, or the like, or payment may be made by a redirect to an independent location at which such payments are accepted. For example, Amazon may present a photograph of a person in need who has just entered a vaccination location, a charitable giver may designate that entering person for receipt of her donation, and the donating person may provide the monetary donation through an Amazon Prime, one-click transaction. Alternatively, the recipient of the donation may be selected based on reviews of photographs in Facebook, and, upon selection of a donation recipient, the donating person may be redirected to PayPal in order to execute the donation transaction.

The funds donated may be provided to an account (such as a Cloud-based account) of the locations at which services are provided (such as a Paypal account, Google wallet, bank account, or the like). Similarly, the funds donated may be accrued in the App for later access by the service provider, or may be subjected to cutting of a paper check based on funds accrued according to the tracked donations.

The foregoing invention may be applicable in any context in which unique designees may be selected for dedicated donation. Such goods and services locations include, by way of non-limiting example, soup kitchens, shelters, vaccination centers, and the like. In the foregoing detailed description, it can be seen that various features are grouped together in individual embodiments for the purpose of brevity in the disclosure. This method of disclosure is not to be interpreted as reflecting an intention that the subsequently claimed embodiments require more features than are expressly recited in each claim.

Further, the descriptions of the disclosure are provided to enable any person skilled in the art to make or use the disclosed embodiments. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather is to be accorded the widest scope consistent with the principles and novel features disclosed herein.

What is claimed is:

1. A method for making charitable contributions, the method comprising:
collecting information related to at least one attribute associated with at least one targeted recipient of a contribution at one of a plurality of service provider locations;
providing said information to at least one server communicatively coupled to at least one donor accessible application, wherein said application is resident on a device having a tangible computing processor, the processor in data communication with a non-transitory computer memory that stores instructions which, when executed on the processor, provides to the at least one donor a graphical user interface; and
receiving through the at least one donor accessible application an authorization to provide a contribution from the at least one donor to the at least one targeted recipient at one of the plurality of service provider locations.

2. The method of claim 1, wherein the contribution is currency.

3. The method of claim 1, wherein the contribution comprises at least one good accessible to ones of the plurality of service provider locations.

4. The method of claim 1, wherein the at least one donor selects the at least one targeted in accordance with the at least one attribute.
